(19) United States
(12) Patent Application Publication
(10) Pub. No.: US 2011/0258912 A1
(43) Pub. Date: Oct. 27, 2011

(54) COUNTER-CURRENT PROCESS FOR BIOMASS CONVERSION

(75) Inventors: Paul O'connor, Hoevelaken (NL); Sjoerd Daamen, Bocairent (ES)

(73) Assignee: KIOR INC., Pasadena, TX (US)

(21) Appl. No.: 13/131,825

(22) PCT Filed: Dec. 10, 2009
(86) PCT No.: PCT/US2009/067572

§ 371 Date: Jul. 11, 2011

(30) Foreign Application Priority Data
Dec. 10, 2008 (EP) 08171256.4

(51) Int. Cl. C10L 1/00; B01J 8/00

(52) U.S. Cl. 44/307; 422/600

(57) ABSTRACT

A countercurrent process is disclosed for converting solid biomass material. The solid biomass material travels through a reactor system in countercurrent with hot heat carrier materials, such as particulate heat carrier material and hot gases. The solid biomass material is subjected to a first conversion at a first temperature T 1, and a second conversion at a second temperature, T 2, such that T 2>T 1. Bio-oil produced to at T 1 is not exposed to the higher temperature T 2. As a result, secondary reactions of the bio-oil components are minimized.

### BACKGROUND OF THE INVENTION

1. Field of the Invention

The invention relates generally to the conversion of biomass material, and more particularly to the catalytic conversion of biomass material to liquid fuel products.

2. Description of the Related Art

Several pyrolysis processes have been proposed for the conversion of biomass material to liquid and gaseous products. It is generally recognized that in particular the liquid pyrolysis products, often referred to as bio-oil, are unstable. For this reason it is important to minimize the exposure of bio-oil to elevated temperatures.

Flash pyrolysis processes have been proposed in a number of variants. The main characteristics that such processes have in common are as follows. Biomass material is introduced into a hot reaction chamber, with or without a particulate heat carrier material. If a heat carrier material is used, this material may be an inert material, a catalytic material, or a combination of the two. An inert gas is used to remove the vaporized and gaseous reaction products from the reaction chamber, by volume replacement. The vaporized reaction products and the gaseous reaction products are entrained in the inert gas flow to a condensor, where the vaporized reaction products are condensed to liquid form, and separated from the inert gas stream and from the gaseous reaction products.

Although the residence time of the reaction products in the reaction chamber maybe short (residence times of less than 1 second are claimed by most authors), the reaction products remain at a high temperature until they reach the condensor. Consequently there is considerable opportunity of secondary reactions taking place with the unstable bio˜oil components. This problem is aggravated by the fact that, in order to obtain acceptable yields, the reaction chamber is kept at a high temperature, typically at or near 500° C.

Thus, there is a particular need for a conversion process for biomass material in which exposure of reaction products of the conversion reaction to elevated temperatures is reduced as compared to prior art flash pyrolysis processes.

### BRIEF SUMMARY OF THE INVENTION

The present invention addresses these problems by providing a countercurrent process for the catalytic conversion of biomass material, said process comprising the steps of:

(i) providing a solid particulate biomass material;
(ii) heating the biomass material to a first temperature, T 1;
(iii) contacting the biomass material in countercurrent with a hot gas and/or a hot particulate heat carrier material to provide a second temperature T 2, whereby T 2>T 1.

Another aspect of the invention is a bio-oil produced by this countercurrent process.

### BRIEF DESCRIPTION OF THE DRAWINGS

The features and advantages of the invention will be appreciated upon reference to the following drawings, in which:

FIG. 1 is a schematic representation of a prior art flash pyrolysis unit;

FIG. 2 is a schematic representation of a first embodiment of the process of the invention;

FIG. 3 is a schematic representation of a variant of the embodiment of FIG. 2;

FIG. 4 is a schematic representation of a second embodiment of the process of the invention;

FIGS. 5, 6 and 7 are schematic representations of separate embodiments of the process of the invention.

### DETAILED DISCLOSURE OF THE INVENTION

The present invention relates to a countercurrent process for the catalytic conversion of biomass material, said process comprising the steps of:

(i) providing a solid particulate biomass material;

(ii) heating the biomass material to a first temperature, T 1;

(iii) contacting the biomass material in countercurrent with a hot gas and/or a hot particulate heat carrier material to provide a second temperature T 2, whereby T 2>T 1.

An essential aspect of the invention is that an important part of the biomass conversion reaction takes place at the lower temperature, T 1 and that reaction products formed at this temperature are not exposed to the higher temperature T 2. Biomass material that is not converted at the lower temperature T 1 is later exposed to the higher temperature, T2, for further conversion. T 1 and T 2 generally differ by 50 to 200 degrees C.

In one embodiment of the invention step (ii) comprises mixing the solid particulate biomass material with a hot heat carrier material. During step (ii) and during later stages of the process, coke and/or char deposits on the heat carrier material. In a preferred embodiment the coke and char deposits are burned off the particulate heat carrier material in a regenerator. The combustion heat of the coke and char is used to supply the necessary reaction heat to the heat carrier material.

The particulate heat carrier material may be an inert material, such as sand, or it may be a catalytic material. The term “catalytic material” as used herein refers to a material that, by virtue of its presence in the reaction zone, affects at least one of the process parameters of conversion, yield and product distribution, without itself being consumed in the reaction. Examples of catalytic materials include the salts, oxides and hydroxides of the alkali metals and the earth alkaline metals, alumina, alumino-silicates, clays, hydrotalcites and hydrotalcite-like materials, ash from the biomass conversion process, and the like. Mixtures of such materials may also be used.

The term “hydrotalcite” as used herein refers to the hydroxycarbonate having the empirical formula Mg₆Al₂(CO₃)(OH)₁₆.xH₂O, wherein x is commonly 4. The term “hydrotalcite-like material” refers to materials having the generalized empirical formula M(II)₆M(III)₂(CO₃)(OH)₁₆.xH₂O, wherein M(II) is a divalent metal ion, and M(III) is a trivalent metal ion. These materials share the main crystallographic properties with hydrotalcite per se.

The particulate biomass material may be contacted with a catalyst prior to step (ii), during step (ii), or both prior to and during step (ii). For example, if the catalyst is a water soluble material, as is the case with the alkali metal and earth alkaline metal compounds, the catalyst may be dissolved in an aqueous solvent, and the biomass material may be impregnated with the aqueous solution of the catalyst prior to step (ii).

The catalyst may be in a particulate form. A particulate solid catalyst can be contacted with the particulate biomass material prior to step (ii) in a separate mechanical treatment step. Such mechanical treatment may include milling, grinding, kneading, etc., of a mixture of the particulate biomass material and the particulate catalyst material.

A catalyst material in particulate solid form can be contacted with the particulate biomass material during step (ii). In a preferred embodiment, the heat carrier material consists of or comprises the particulate solid catalyst.

Char and coke deposit on the particulate heat carrier material. Inorganic materials present in the particulate biomass starting material are converted to ash during the conversion reaction. The process of the invention produces a solid by-product consisting predominantly of the particulate heat carrier material, which may comprise, or consist of, solid catalyst material, coke, char, and ash. Although char may itself be liquid, when deposited on particulate solid materials it can be considered a solid by-product of the process.

In a preferred embodiment these solid by-products are subjected to a high temperature and an oxygen-containing atmosphere (such as air) in a regenerator. Char and coke are combusted, and heat generated thereby is used to increase the temperature of the heat carrier material. This heat is transported back into the process of the invention.

The main reaction products of the process are vaporized liquids, i.e., condensable gases, and gaseous reaction products. The condensable gases and the gaseous reaction products are entrained by the hot gas of step (iii) to a first condensor, where at least part of the condensable gases are converted to a liquid.

Non-condensable gas emanating from the condensor may be combusted to produce a hot flue gas. The hot flue gas can be used as the hot gas with which the biomass material is contacted in step (iii) of the process. Excess heat from this combustion process can be used to heat the heat carrier material. Flue gas from the regenerator can also be used as the hot gas with which the biomass material is contacted in step (iii) of the process.

It is desirable to provide a hot gas for use in step (iii) that has reducing properties. This can be accomplished by operating the regenerator and/or the combustion of the noncondensable gases in such a way as to produce a flue gas containing a significant quantity of carbon monoxide (CO). In general, CO is formed when combustion of carbon-containing materials is carried out with sub-stoichiometric amounts of oxygen.

It may be desirable to further increase the reducing properties of the hot gas to be used in step (iii) by adding hydrogen donor gases, such as methane or other hydrocarbons.

The process of the invention may be carried out in a cascade of at least two reactors, whereby the first reactor is used for step (ii). The first reactor may be a cyclone, in which biomass particles at high velocity are brought into contact with solid heat carrier particles. The temperature in the first reactor suitably is maintained at 200 to 450° C., preferably from 300 to 400° C. more preferably from 320 to 380° C.

In an alternate embodiment the process is carried out in a countercurrent (gas-up) downer, which is a vertical tube in which the particulate solid materials travel from top to bottom, in countercurrent with an upward flow of hot gas. The temperature near the bottom of the tube is in the range of 450 to 550° C., preferably in the range of from 480 to 520° C. The temperature near the top of the tube is in the range of 250 to 350° C.

### DESCRIPTION OF ILLUSTRATIVE EMBODIMENTS

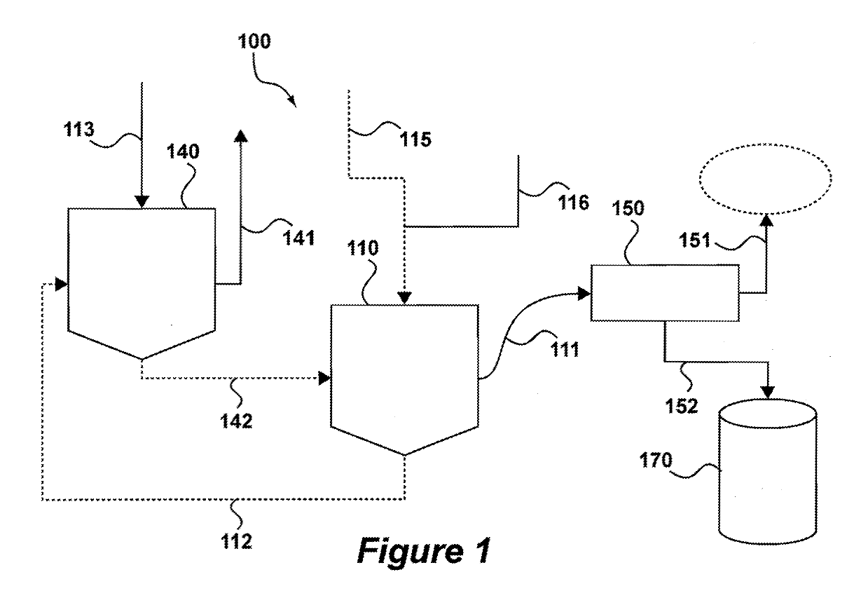

The following is a description of certain embodiments of the invention, given by way of example only and with reference to the drawings. Referring to FIG. 1, a schematic representation is shown of a flash pyrolysis unit 100 representative of the prior art processes. Particulate solid biomass 115 is introduced into reactor 110, which is kept at the desired conversion temperature, typically at or near 500° C. An inert gas 116, for example steam, nitrogen, or a steam/nitrogen mixture, is introduced into reactor 110, in order to entrain gaseous reaction products 111 to condensor 150, where condensable gases are converted to liquid bio-oil 152. The bio-oil is separated from the non-condensable gases 151, and sent to storage container 170.

Solids and char 112 from reactor 110 are sent to regenerator 140, and contacted with air 113. The temperature in regenerator 140 typically is about 650° C. Flue gas 141 is predominantly CO2. Hot heat carrier particles 142 from regenerator 140 are recycled back into reactor 110.

While still present in reactor 110, the reaction products are exposed to the reaction temperature of (near) 500° C. Even after reaching condensor 150 it takes some time for the temperature of the reaction products to drop below 350° C. Consequently, the reaction products are subjected to secondary reactions, which impair the quality of bio-oil 152.

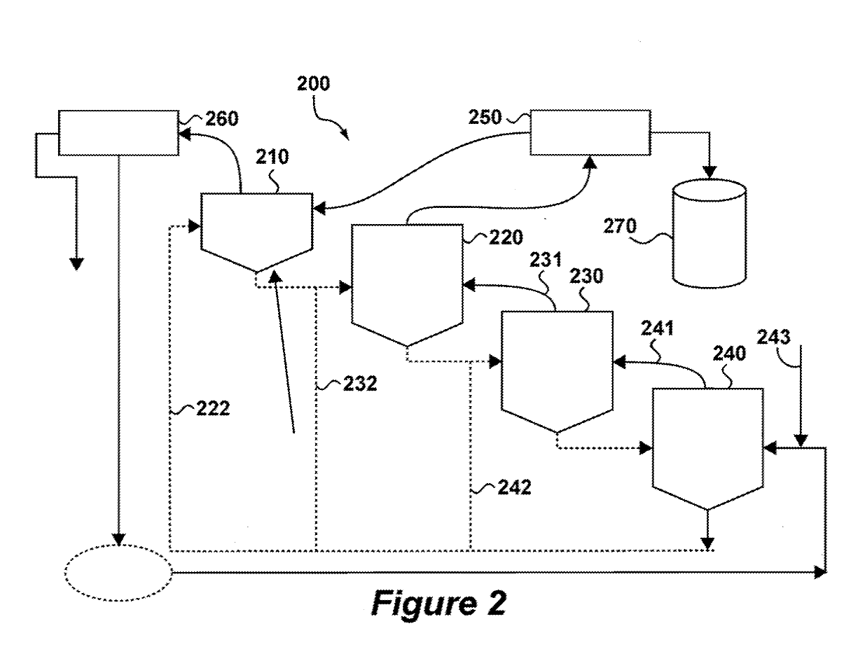

FIG. 2 shows a schematic representation of one specific embodiment of the invention. Unit 200 comprises a mechanical treatment reactor 210, a first conversion reactor 220, a second conversion reactor 230, a regenerator 240, a first condensor 250, and a second condensor 260.

Solid particulate biomass and solid particulate catalyst are mixed and mechanically treated in mechanical treatment reactor 210. The mechanical treatment can be grinding, milling, kneading, and the like. It will be understood that the mechanical treatment will result in providing intimate contact between the catalyst particles and the biomass particles. The mechanical treatment reactor 210 may be operated at elevated temperature, if desired, to accomplish a partial drying of the biomass. The temperature in mechanical treatment reactor 210 may be maintained in a range from ambient to 200° C., preferably from 80 to 150 degrees C. Heat is provided by the catalyst particles, which leave regenerator 240 at a very high temperature. In particular if mechanical treatment reactor 210 is operated at the high end of the stated temperature range, some biomass conversion will take place. Gaseous products emanating from mechanical treatment reactor 210 are transferred to second condensor 260, where noncondensable gaseous products are separated from condensable vapors (primarily water).

From mechanical treatment reactor 210 the biomass/catalyst mixture is transferred to first conversion reactor 220. First conversion reactor 220 is operated at a temperature between 200 and 450° C., more typically between 300 and 400 degrees C., preferably at or near 350 degrees C. Heat is provided by additional hot catalyst from regenerator 240, as well as hot gas from second conversion reactor 230.

Significant biomass conversion takes place in first conversion reactor 220. Reaction products, which comprise both condensable gases and non-condensable gases, are transferred to first condensor 250. Non-condensable gases may be used as a heat source. The condensable gases, once liquefied, form a good quality bio-oil. Desirably this bio-oil has an oxygen content lower than 25 wt %, preferably lower than 15 wt %, and a Total Acid Number (TAN) lower than 30, preferably lower than 10. Importantly, the reaction products of first conversion reactor 220 never “see” a temperature higher than the operating temperature of first conversion reactor 220, e.g., 350° C. This is a much lower temperature than the 500° C. to which the reaction products are exposed in the prior art pyrolysis unit of FIG. 1. It will be understood that the bio-oil produced in first conversion reactor 220 of FIG. 2 is of significantly better quality than the bio-oil produced in reactor 110 of FIG. 1, because of this temperature difference.

Solids from first conversion reactor 220 are transferred to second conversion reactor 230. These solids consist primarily of unconverted biomass; solid biomass reaction products, including coke and char; catalyst particles; and ash.

The temperature in second conversion reactor 230 is typically maintained in the range of 400 to 550° C., more typically in the range of from 450 to 520° C. This higher temperature, as compared to first conversion reactor 220, results in additional conversion of the biomass, thus ensuring an acceptable bio-oil yield. Although the quality of the bio-oil produced in second conversion reactor 230 is inferior to that produced in first conversion reactor 220, the overall quality of the bio-oil is better than if the entire conversion is carried out at the higher temperature.

Heat is provided to second conversion reactor 230 by hot gas 241 from regenerator 240, and by hot catalyst 242 from regenerator 240. Reaction products from second conversion reactor 230 are transferred as hot gas 231 to first conversion reactor 220. In the alternative, the reaction products from second conversion reactor 230 may be sent to a third condenser (not shown), if it is desired to keep the product streams from reactors 220 and 230 separate. In that case, the heat for reactor 220 is provided entirely by hot catalyst 232.

Solids from second conversion reactor 230 are transferred to regenerator 240. These solids consist predominantly of coke, char, catalyst particles, and ash. Coke and char are burned off in regenerator 240 by supplying an oxygen containing gas 243, for example air. As shown in FIG. 2, gaseous products from the process may be burned in regenerator 240 as well, if the heat balance of the process so requires. In most cases the amount of coke and char available to regenerator 240 is more than sufficient to provide the necessary process heat.

It may be desirable to operate regenerator 240 at a sub-stoichiometric amount of oxygen, so that hot gas 241 contains significant amounts of carbon monoxide (CO). Carbon monoxide has reducing properties, which are beneficial to the biomass conversion process. Likewise, regenerator 240 may be operated such that residual coke is present on hot catalysts 222, 232, and 242. The residual coke imparts reducing properties to the reaction mixtures in the various reactors.

Furthermore, hydrocarbon gases from condensors 250 and 260 may be injected into one or more reactors of the process, so as to provide hydrogen donor presence in the reaction mixtures. Each of these measures acts to reduce the oxygen content of the bio-oil produced in the process.

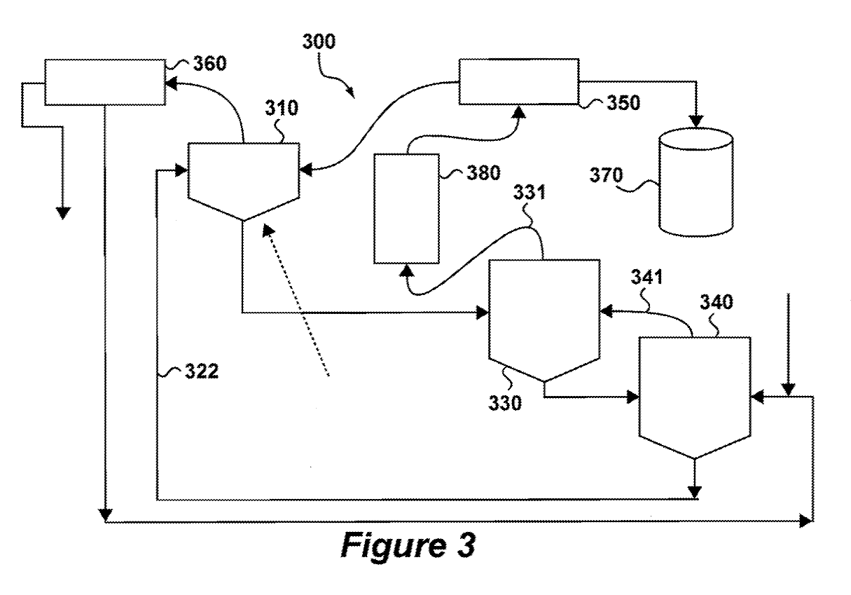

FIG. 3 shows a schematic representation of a variant of the embodiment shown in FIG. 2. Unit 300 comprises a mechanical treatment reactor 310, a first condensor 350, and a second condensor 360. As in the embodiment of FIG. 2, regenerator 340 produces hot gas 341 and hot particulate heat carrier material 322.

In this variant, reaction product from second conversion reactor 330 is passed through catalytic cracker 380. The catalyst in catalytic cracker 380 is acidic in nature. Suitable examples include acidic zeolites, for example HZSM-S. The cracking reaction taking place in catalytic cracker 380 further improves the quality of bio-oil 370. Hot gas 331 from second conversion reactor 330 is sent to catalytic cracker 380.

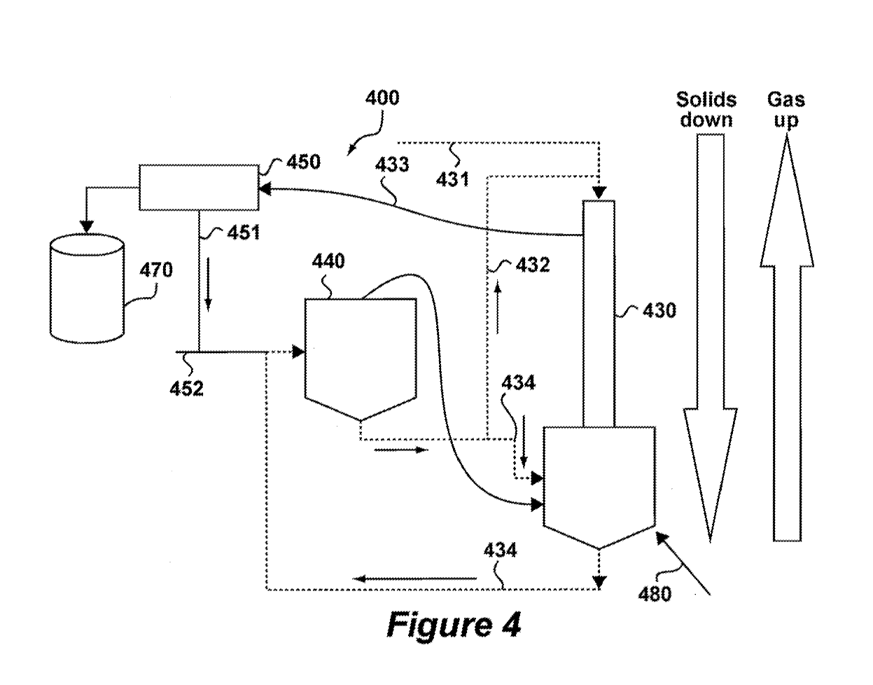

FIG. 4 shows an alternate embodiment of the process of the invention. Unit 400 comprises a countercurrent downer 430, in which gas moves upward, and solids move downward. Biomass particles 431 are fed to downer 430 at the top, together with hot catalyst particles 432 from regenerator 440. Downer 430 is operated such that the temperature at the bottom is at or near 500° C.; the temperature at the top of downer 430 is below 350° C., for example 300° C. Heat is supplied to downer 430 by hot gas 434 and hot catalyst 432.

Gaseous and vaporized liquid reaction products are collected near the top of downer 430, and transferred to condensor 450. Bio-oil from condensor 450 is stored in tank 470. Gaseous products 451 from condensor 450 are transferred to regenerator 440, after mixing with air flow 452.

Solid residue, consisting predominantly of catalyst particles, ash, coke and char, is collected in stripper 480. Inert gas (not shown) is used to remove volatile reaction products from the solid residue in stripper 480. Stripper 480 may be heated with hot catalyst from stream 434. Coke and char are burned off the solid particles in regenerator 440.

Ash may be separated from the solid catalyst particles leaving regenerator 440. The ash may be used outside of the process, for example as fertilizer, or may be pelletized to the desired particle size and recycled into the process, for example mixed with hot catalyst 432.

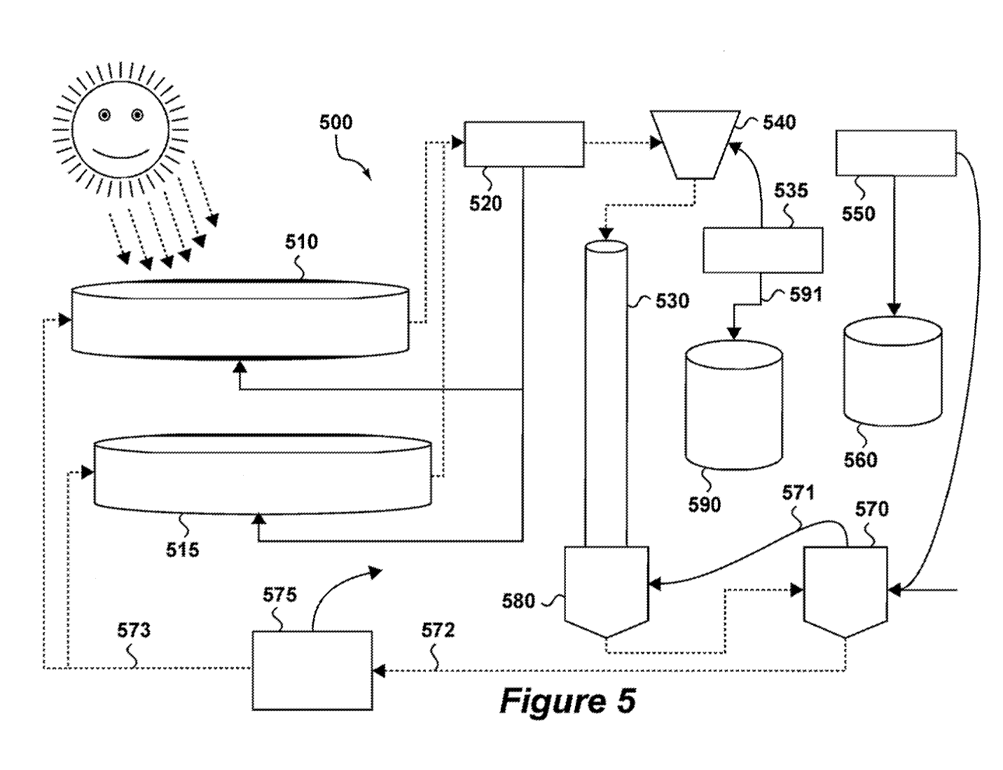

FIG. 5 shows a schematic representation of an embodiment of the invention tailored to the conversion of aquatic biomass. Unit 500 comprises countercurrent (gas up, solids down) downer 530. Aquatic biomass is grown in pond 510. Desirably, the aquatic biomass is grown on mineral pellets, to facilitate subsequent separation of water.

Wet aquatic biomass from pond 510 is transferred to filter 520, where most of the water is removed. From filter 520 the aquatic biomass is transferred to drying reactor 540, which is kept at or near 100° C. for removal of most of the residual water. Vapors from drying reactor 540 are condensed in first condensor 550. Liquid water from first condensor 550 is stored in storage tank 560. Water from first condensor 550 is of sufficient quality to be used for irrigation and household purposes, even cooking and drinking.

Dried aquatic biomass from drying reactor 540 is fed to the top of downer 530. The biomass moves downward in downer 530, in countercurrent with hot gas 571 from regenerator 570, which is fed into the downer at stripper 580.

Downer 530 is operated such that the temperature at the bottom is at or near 450° C., and the temperature at the top is at or near 300° C. It will be understood that aquatic biomass generally contains no or little lignin, and may be converted at lower temperatures than the process embodiments described herein above.

The required heat for downer 530 is supplied by hot gas 571 and, to a much lesser extent, by drying reactor 540, which heats the biomass and the mineral particles to a temperature of approximately 100° C. If desired additional heat may be supplied by diverting part of hot mineral particles 572 to the top of downer 530.

As depicted, hot mineral particles from regenerator 570 are cooled in heat exchanger 575. Heat recovered from the mineral particles may be supplied to drying reactor 540, to downer 530, or to pond 510, for example.

Mineral particles 573 leaving heat exchanger 575 may be recycled to growth pond 510. Part of the mineral particles 573 may be sent to holding tank: 515, which contains water from filter 520. The mineral particles capture organic residue present in holding tank: 515. The mineral particles laden with organic material may be recycled to filter 520, or to drying reactor 540.

Gaseous and vaporized liquid reaction products from downer 530 are sent to second condensor 535, where the vaporized liquids are condensed to bio-oil 591, which is sent to storage tank 590.

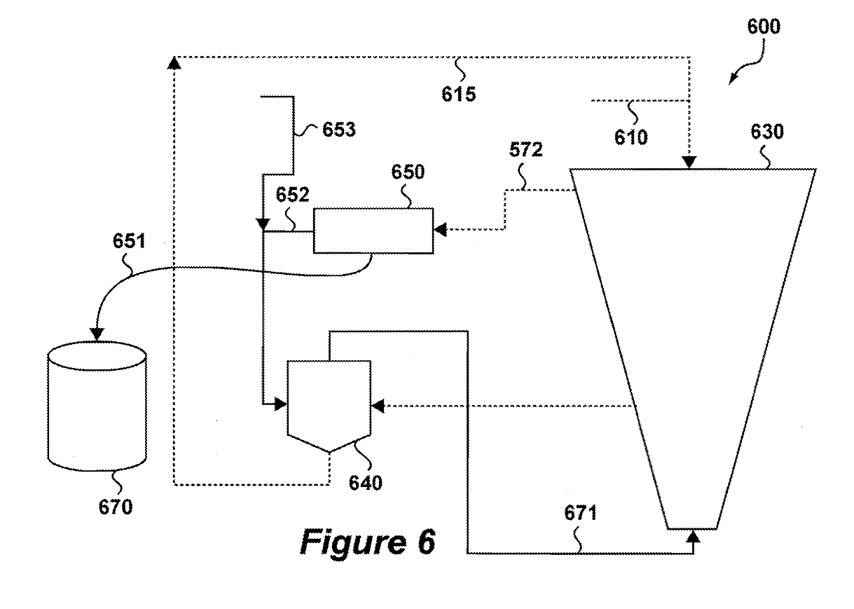

FIG. 6 shows a schematic representation of yet another embodiment of the inventive process. Unit 600 comprises a countercurrent spouted bed reactor 630. Particulate biomass 610 is fed into reactor 630 at the top, optionally together with hot catalyst 615 from regenerator 640.

Hot gas 671 from regenerator 640 is fed to the bottom of reactor 630. Gaseous and vaporized reaction products 631 are transferred to condensor 650, where vaporized reaction products are liquefied to bio-oil 651, which is stored in storage tank 670. Gaseous reaction products 652 are mixed with air 653, and sent to regenerator 640.

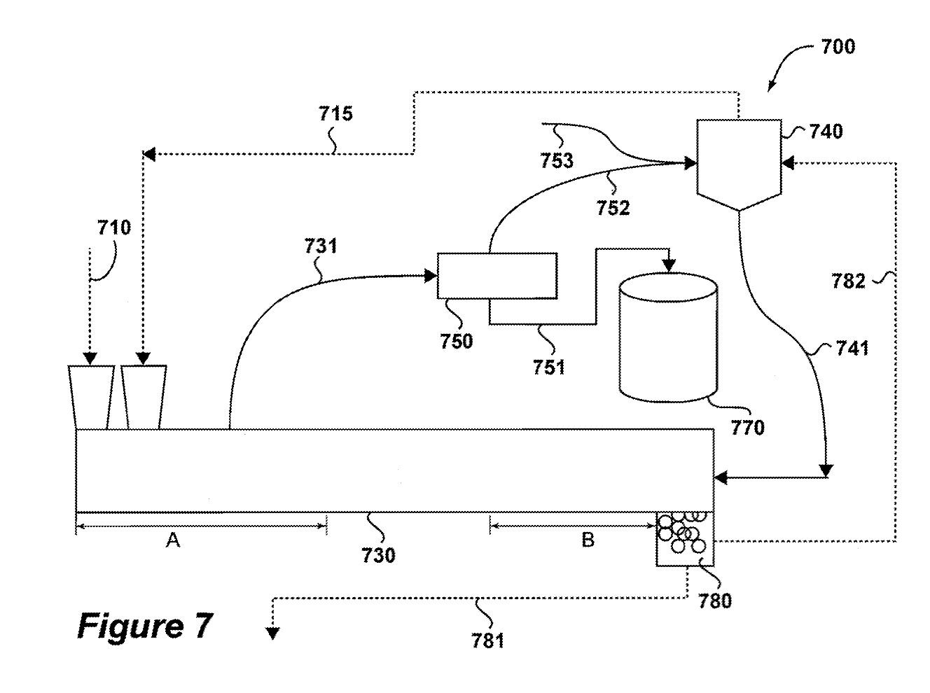

FIG. 7 shows a schematic representation of yet another embodiment of the inventive process. Unit 700 comprises an auger reactor 730. Biomass 710 is fed into auger reactor 730 at zone A, together with heat carrier particles 715. The auger screw is operated such that the biomass particles and the heat carrier particles travel from zone A in the direction of zone B, in countercurrent with hot gas 741 from regenerator 740. The auger reactor is operated such that zone A is kept at or near 300° C., and zone B is kept at or near 500° C. Heat is supplied to reactor 730 by hot heat carrier particles 715 and hot gas 741.

Gaseous and vaporized liquid reaction products are transferred to condensor 750, where the vaporized liquid products are condensed to bio-oil 751, which is sent to storage tank: 770.

Gaseous reaction products 752 from condensor 750 are mixed with air 753, and sent to regenerator 740.

Solids from auger reactor 730 are collected in separator 780, where the solids are split into a char/ash stream 781 and a coke-laden heat carrier particle stream 782. The latter are regenerated in regenerator 740.

1. A countercurrent process for the conversion of biomass material, said process comprising the steps of
(i) providing a solid particulate biomass material;
(ii) heating the solid particulate biomass material to a first temperature T1 in a first conversion zone to thereby convert a first portion of the solid particulate biomass material into first gaseous reaction products while leaving a second portion of the solid particulate biomass material unconverted;
(iii) transferring at least part of the first gaseous reaction products from the first conversion zone to a first condenser; and
(iv) heating at least part of the second portion of the solid particulate biomass material to a second temperature T 2 in a second conversion zone by contacting the second portion of the solid particulate biomass material with a hot gas flowing countercurrent to the solid articulate biomass material and/or a hot particulate heat carrier material wherein T2>T1.

2. The process of claim 1 wherein step (ii) comprises mixing the solid particulate biomass material with a hot heat carrier material.

3. The process of claim 2 wherein, prior to or during step (ii), the solid particulate biomass material is contacted with a catalyst.

4. The process of claim 3 wherein the catalyst is in a solid particulate form.

5. The process of claim 4 wherein the heat carrier material comprises the solid particulate catalyst.

6. The process of claim 5 wherein a mixture of solid reaction by-products and solid particulate catalyst is retrieved from the first conversion zone.

7. The process of claim 6 comprising the farther step of separating the solid particulate catalyst from the solid reaction by-product.

8. The process of claim 1 wherein said first gaseous reaction product comprises condensable and non-condensable gases, further comprising the step of converting at least part of the condensable gases to a liquid in the first condenser.

9. The process of claim 8 further comprising the step of combusting at least part of the non-condensable gases.

10. The process of claim 9 wherein heat generated by the combustion of the at least part of the non-condensable gases is used to heat the heat carrier material.

11. The process of claim 10 wherein at least part of the flue gas produced in the combustion of the at least part of the non-condensable gases is used as the hot gas in step (iv).

12. The process of claim 11 wherein flue gas is separated from heat carrier material in a cyclone.

13. The process of claim 11 wherein the flue gas comprises CO.

14. The process of claim 1 which is carried out in a cascade of at least two reactors.

15. The process of claim 14 wherein the first of the cascade of reactors is a cyclone.

16. The process of claim 15 wherein, in the first of the cascade of reactors, biomass particles are brought into contact at high velocity with solid heat carrier particles.

17. The process of claim 1 wherein the first conversion zone is operated at a temperature in the range of from 80 to 50° C.

18. The process of claim 1 which is carried out in a series of at least two vertical tube reactors.

19. The process of claim 1 which is carried out in a countercurrent auger reactor.

20. The process of claim 1 which is carried out in a series of vertical tube reactors.

21. An apparatus for carrying out the process claim 1, said apparatus comprising (i) a first reactor operated at a temperature in the range of from 80 to 50° C., wherein biomass particles are mixed with catalyst particles; (ii) a second reactor operated at a temperature in the range of 200-450° C.; and (iii) a third reactor operated at a temperature in the range of from 400 to 550° C.

22. The process of claim 1 wherein said first and second conversion zones are located in separate reactors.

23. The process of claim 1 wherein said first and second conversion zones are distinct zones of a single reactor.

24. The process of claim 1 wherein T 1 and T 2 differ by 50 to 200° C.

25. The process of claim 1 further comprising the step of condensing at least part of the first gaseous reaction products in the first condenser to thereby form liquid bio-oil.

26. The process of claim 1 wherein said heating of step (iv) converts at least part of the second portion of the biomass material into second gaseous reaction products.

27. The process of claim 26 further comprising the step of condensing at least part of the second gaseous reaction to thereby form liquid bio-oil.

28. The process claim 1 wherein flash pyrolysis is carried out in at least one of the first and second conversion zones.

29. The process of claim 28 wherein said flash pyrolysis is carried out in the presence of a catalyst.
